(19) United States
(12) Patent Application Publication
(10) Pub. No.: US 2012/0161943 A1
(43) Pub. Date: Jun. 28, 2012

(54) ELECTRONIC TAGS, ESL SYSTEM, METHOD FOR SETTING TIME INFORMATION OF ESL SYSTEM AND METHOD FOR OPERATING ESL SYSTEM

(76) Inventors: Gi Young Byun, Incheon (KR); Yun Jong Lee, Suwon-si (KR); Chang Soo Lim, Seoul (KR); Ung Han Moon, Suwon-si (KR)

(21) Appl. No.: 13/193,512

(22) Filed: Jul. 28, 2011

(30) Foreign Application Priority Data
Dec. 28, 2010 (KR) 10-2010-0136761

(51) Int. Cl. H04Q 5/22

(52) U.S. Cl. 340/10.6

(57) ABSTRACT

Disclosed herein are an electronic tag, an ESL system, a method for setting time information of the ESL system, and a method for operating the ESL system. The electronic tag includes: a communication interface unit transmitting and receiving data; a display unit displaying the information of the product; a power supply unit supplying power; a control unit controlling the communication interface unit, the display unit, and the power supply unit and processing data; and a memory unit storing data required to process data in the control unit, and the control unit possesses time information appropriated in real time.

### CROSS REFERENCE(S) TO RELATED APPLICATIONS

This application claims the benefit under 35 U.S.C. Section 119 of Korean Patent Application Serial No. 10-2010-0136761, entitled “Electronic Tags, ESL System, Method for Setting Time Information of ESL System and Method for Operating ESL System” filed on Dec. 28, 2010, which is hereby incorporated by reference in its entirety into this application.

### BACKGROUND OF THE INVENTION

1. Technical Field

The present invention relates to electronic tags, an ELS system, a method for setting time information of the ESL system, and a method for operating the ESL system, and more particularly, to a method that can allow electronic tags to possess real-time time information, calibrate the time information to be approximate to time information of a server, and perform a reservation function by using the time information.

2. Description of the Related Art

Labels displaying information and prices of products have been used in order to display and sell a considerable number of articles within predetermined spaces such as various distribution stores, and the like.

In general, pricing statement labels have been used by a method in which product information required for selling, e.g., price and discount information are directly handwritten on paper or printed on paper according to standardized formats to be attached to a section around a displayed location of the corresponding product.

Although the related art seems to be simple and convenient, and be implemented at low cost, in the case where standardized formats are used for ten thousands or more of product items and prices thereof frequently vary like in large-sized distribution stores, and as a result, the existing paper label applying scheme is limited.

That is, when some of ten thousands or more of product items fluctuate in prices, they are condensed and product information such as fluctuating prices and the like is handwritten or printed and thereafter, labels must be calibrated and replaced at the location of the corresponding product sold and displayed in the distribution store.

Whenever the price information of the product is changed, time for the operation and replacement and workforces are required and a need to improve the time and workforces is large concern in consideration of a feature of the large-sized distribution store.

That is, it is necessary to develop the means capable of changing the product information rapidly, accurately and easily only within minimum additional cost.

In recent years, an attempt to substitute the existing paper label with electronic tags using an electronic device has been made based on such a market demand. That is, the reason therefor is that the product information can be changed rapidly, accurately, and easily by using communications and electronic display technologies.

Even though the electronic tags are called diverse terms such as an electronic shelf label (ESL), an electronic price label (EPL), electronic information label (EIL), and the like according to different languages/cultures among organizations or countries that are developing relevant technologies, they merely represent the differences of culture/language to recognize and describe the existing labels and electronic tags while their purpose and usages are almost identical to each other.

Hereinafter, in the present invention, they will be expressed as “ [symbol] ” in Korean and “ESL” in English.

Meanwhile, the electronic tag does not possess time information due to limitations such as power supply, miniaturization, and saving manufacturing cost.

Further, as described above, since the time information is not ensured in the electronic tag, data which a server transmits to the electronic tag cannot but be immediately displayed as a screen received in the electronic tag in an ESL system and since considerable data traffic are instantaneously generated in updating data of all electronic tags in the distribution store having a lot of electronic tags, the capacity of network communication equipment must be fully ensured so as to handle the data traffic and an increase in capacity of the communication equipment eventually causes the volume of the equipment and manufacturing cost to be increased.

Further, in the known ESL system, when the data transmitted from the server is received by the electronic tag, the received data is immediately displayed. Therefore, when an error occurs, the error is directly exposed to customers without ensuring time enough to calibrate the error.

### SUMMARY OF THE INVENTION

An object of the present invention is to provide electronic tags capable of possessing time information.

Further, another object of the present invention is to provide an ESL system and a method for setting time information of the ESL system capable of synchronizing time information of the electronic tags and time information of a server by including the electronic tags.

Yet another object of the preset invention is to provide a method for setting time information of the ESL system capable of reducing an error in time information between the electronic tags and the server.

Yet another object of the present invention is to provide a method for operating the ESL system capable of using a reservation function in the ESL system in which the time information of the electronic tags and the time information of the server are synchronized with each other.

According to an exemplary embodiment of the present invention, there is provided an electronic tag including: in displaying product information transmitted from a server, a communication interface unit transmitting and receiving data; a display unit displaying the information of the product; a power supply unit supplying power; a control unit controlling the communication interface unit, the display unit, and the power supply unit and processing data; and a memory unit storing data required for the control unit to process data, wherein the control unit possesses time information appropriated in real time.

In this case, the electronic tag may further include a real-time clock connected to the control unit and appropriating time information.

The electronic tag may further include a timer and/or counter connected to the control unit and appropriating time information.

The control unit may include a microcontroller with an oscillator.

The electronic tag may further include a register storing the time information.

The electronic tag may further include a time setting register appropriating and storing the time information in real time.

The electronic tag may further include: a time setting register appropriating and storing time information acquired from the outside in real time; a second register storing time information acquired from the outside; and a first register storing time information lastly acquired from the outside.

According to another exemplary embodiment of the present invention, there is provided an ESL system including a server including a database storing product information and transferring a command and data to the electronic tag.

In this case, the ESL system may further include a wired/wireless communication converting unit relaying wireless communication between the server and the electronic tag.

Time information of the server and time information of the electronic tag may be synchronized with each other.

Meanwhile, according to another exemplary embodiment of the present invention, there is provided a method for setting time information of an ESL system, including: in operating the ESL system including a server and an electronic tag, (a) transmitting time information set in the server to the electronic tag through a wired/wireless communication network; (b) receiving and storing time information from the electronic tag; and (c) appropriating and possessing the stored time information in real time.

In this case, in step (a), an electronic tag wakeup command signal coupled with time information may be transmitted from the server.

In step (b), the electronic tag may receive and store the time information transmitted from the server in wakeup while repeating wakeup and sleep at a predetermined period.

Further, in step (b), the electric tag may receive time information and stores the received time information in a register.

Further, in step (c), the stored time information may be appropriated and stored in real time by a timer and/or counter.

Further, in step (c), the stored time information may be appropriated and stored in real time by a real-time clock.

According to another exemplary embodiment of the present invention, there is provided a method for setting time information of an ESL system, including: in operating the ESL system including a server and an electronic tag, n times-sectioning dividing the wakeup signal generated by the server and transmitting real-time time information corresponding to the sectioned wakeup signal together with the wakeup signal; and storing, by the electronic tags which wake up at predetermined wakeup periods, respectively, the time information received at the time of wakeup, and appropriating and possessing the stored time information in real time.

According to another exemplary embodiment of the present invention, there is provided a method for setting time information of an ESL system, including: in operating the ESL system including a server, a wired/wireless communication converting unit, and an electronic tag, synchronizing time information of the server and time information of the wired/wireless communication converting unit with each other; n times-sectioning dividing the wakeup signal generated by the wired/wireless communication converting unit and transmitting real-time time information corresponding to the sectioned wakeup signal together with the wakeup signal; and storing, by the electronic tags which wake up at predetermined wakeup periods, respectively, the time information received at the time of wakeup, and appropriating and possessing the stored time information in real time.

Meanwhile, according to another exemplary embodiment of the present invention, there is provided a method for setting time information of an ESL system, including: in operating the ESL system including an electronic tag with a first register, a second register, and a time setting register, and a server, (a) transmitting time information set in the server through a wired/wireless communication network; (b) receiving the time information and storing the received time information in each of the first register, the second register, an the time setting register when the electronic tag wakes up and appropriating the time information stored in the time setting register in real time; (c) waking up, by the electronic tag, again to receive the time information after ½^{m} of the period T0 of the wakeup signal of the server has elapsed and storing the received time information in the first register; (d) comparing the time information stored in the first register and the time information stored in the second register with each other and substituting the time information stored in the second register and the time setting register with the time information stored in the first register when the time information stored in the first register and the time information stored in the second register are different from each other; (e) adding 1 to m; and (f) terminating the process when m passing through step (e) is larger than the predetermined number of times, k and feeding back the process to step (c) when m is equal to or smaller than k.

In this case, when the time information stored in the first register and the time information stored in the second register are the same as each other in step (d), step (e) may be performed.

The wired/wireless communication converting unit may be provided between the server and the electronic tag, and in step (a), the wired/wireless communication converting unit may receive the time information set in the server and transmit the received time information through a wired/wireless communication network.

According to another exemplary embodiment of the present invention, there is provided a method for setting time information of an ESL system, including: in operating the ESL system including a server and an electronic tag, transmitting time information from the server; waking up all electronic tags included in the ESL system at once; and storing time information received at the time when the electronic tag wakes up and appropriating and possessing the stored time information in real time.

In this case, a wired/wireless communication converting unit may be provided between the server and the electronic tag, and when the server transmits time information, the wired/wireless communication converting unit may receive the time information and transmit the received time information to the electronic tag.

According to another exemplary embodiment of the present invention, there is provided a method for operating an ESL system in which a signal transmitted from the server to the electronic tag includes execution reservation time information, and the electronic tag operates in accordance with the execution reservation time information included in the signal received from the server.

Further, a data signal transmitted from the server to the electronic tag may include electronic tag identity, product information, and execution reservation time information.

Further, the data signal transmitted from the server to the electronic tag may be constituted by a header and data, and the header may include the execution reservation time information.

Meanwhile, according to another exemplary embodiment of the present invention, there is provided a method for operating an ESL system, wherein in using a method for setting time information of the ESL system, a signal transmitted from a server or a wired/wireless communication converting unit to an electronic tag includes execution reservation time information, and the electronic tag operates in accordance with the execution reservation time information included in the signal received from the server or the wired/wireless communication converting unit.

In this case, a data signal transmitted from the server or the wired/wireless communication converting unit to the electronic tag may include electronic tag identity, product information, and execution reservation time information.

Further, the data signal transmitted from the server or the wired/wireless communication converting unit to the electronic tag may be constituted by a header and data, and the header may include the execution reservation time information.

### BRIEF DESCRIPTION OF THE DRAWINGS

FIG. 1 is a diagram showing a configuration of an ESL system according to an exemplary embodiment of the present invention;

FIG. 2 is a diagram showing a detailed configuration and a connection relationship of an ESL system according to an exemplary embodiment of the present invention;

FIG. 3 is a block diagram showing a configuration of an electronic tag according to an exemplary embodiment of the present invention;

FIG. 4 is a block diagram showing a configuration of an electronic tag according to another exemplary embodiment of the present invention;

FIG. 5 is a diagram showing a data communication process according to an exemplary embodiment of the present invention;

FIG. 6 is a diagram showing a data communication process according to another exemplary embodiment of the present invention;

FIG. 7 is a diagram showing a time acquiring path of an electronic tag according to an exemplary embodiment of the present invention;

FIG. 8 is a diagram showing a time series relationship between a wakeup time and a wakeup period;

FIG. 9 is a flowchart showing a time information calibrating process according to an exemplary embodiment of the present invention;

FIG. 10 is a block diagram showing a configuration applied at the time of calibrating time information according to an exemplary embodiment of the present invention; and

FIG. 11 is a diagram showing a method for operating an ESL system according to an exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an operation of the present invention will be described in more detail with reference to the accompanying drawings.

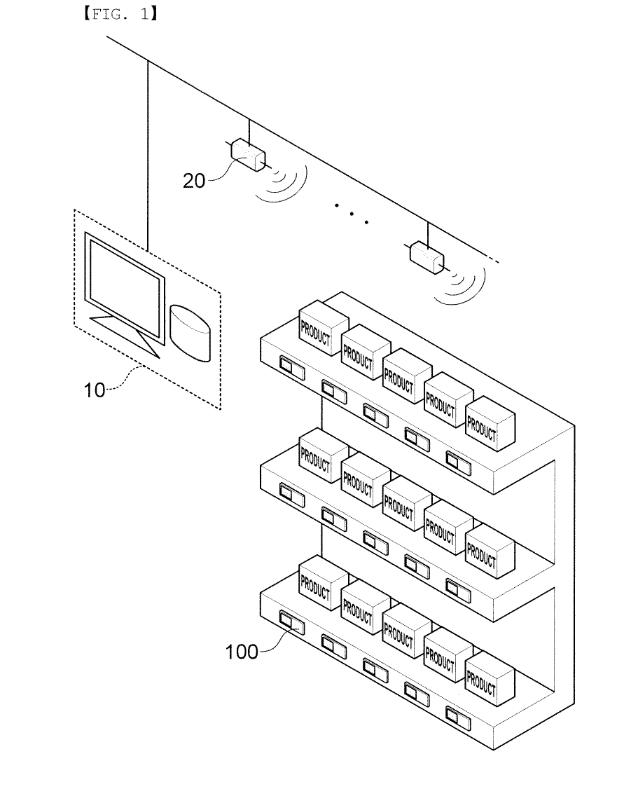

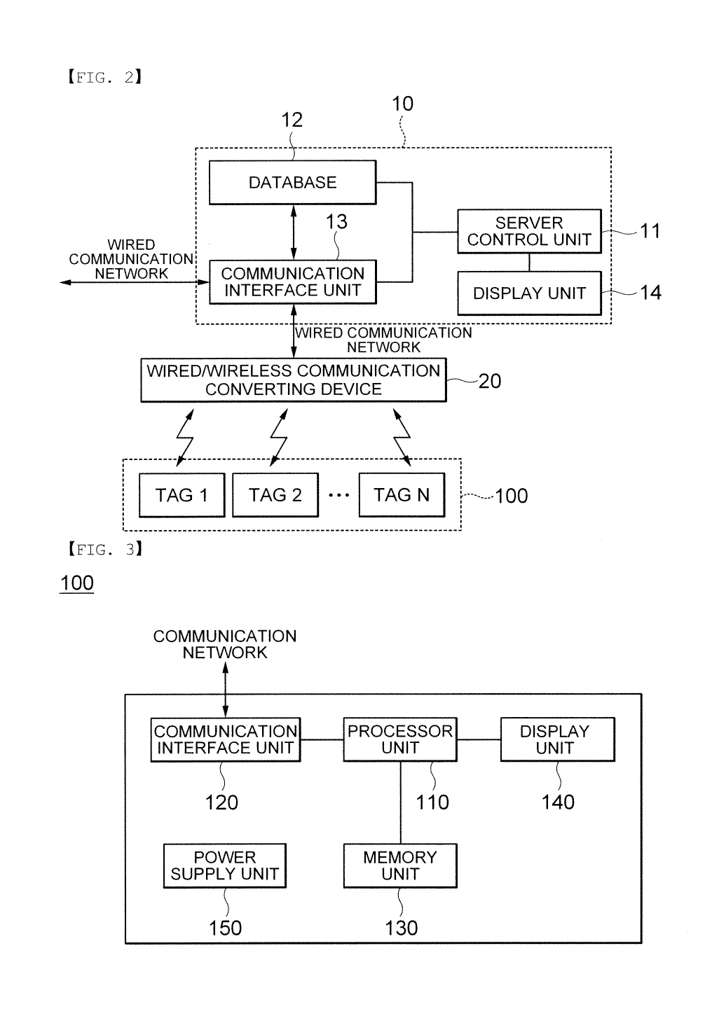

FIG. 1 is a diagram showing a configuration of an ESL system according to an exemplary embodiment of the present invention and FIG. 2 is a diagram showing a detailed configuration and a connection relationship of an ESL system according to an exemplary embodiment of the present invention.

Referring to FIGS. 1 and 2, the ESL system may generally include a server 10, electronic tags 100 and 200 and a communication network. In this case, even the electronic tags 100 and 200 that are installed spaced apart from the server 10 by including a wired/wireless communication converting unit 20 such as a general gateway smoothly access the communication network to transmit and receive data.

In general, the server 10 of a database 12 is built up based on a wired communication network such as a TCP/IP network, while the electronic tags 100 and 200 are connected with the communication network primarily through a wireless scheme.

Therefore, the means capable of relaying the wired communication network and the wireless communication network and converting data is required. Herein the wired/wireless communication converting unit 20 may serve as the corresponding means.

Meanwhile, a detailed system configuration will be described with reference to FIG. 2. The server 10 may include a database 12, a communication interface unit 13, a server control unit 11, and a display unit 14.

The database 12 may store product information and an identification number of the electronic tag 100.

The server 10 transmits various commands and data to the electronic tag 100 and includes the communication interface unit 13 for wired and wireless communications, which includes the database 12 and may include a graphic user interface (GUI) such as the display unit 14.

Meanwhile, although not shown in the figure, in order to ensure convenience in using the ESL system, the server may additionally include diverse devices a hand held device (HHD) such as a PDA, a printer, and the like.

As the wireless communication scheme which can be applied to the ESL system, diverse means such as ZigBee, RFID, IR, RF, and the like are applicable and may be selected by considering efficiency, cost, and the like of the system configuration. As a result, although a difference in a configuration of hardware and implementing communication and operation software may be present, the overall configuration pattern and constituent components are substantially identical to each other.

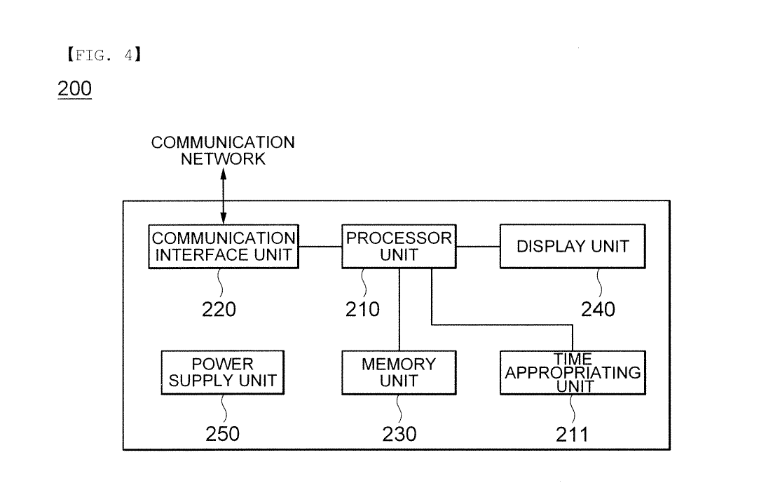

FIG. 3 is a block diagram showing a configuration of an electronic tag 100 according to an exemplary embodiment of the present invention.

Referring to FIG. 3, the electronic tag 100 displays product information received from the server 10 to transfer information and contribute to the sale of the product. In order to perform the function, the electronic tag 100 may include a communication interface unit 120 processing communications, a control unit 110 and a memory unit 130 taking charge of information processing, a display unit 140 including a display panel and a driving circuit, and a power supply unit 150 supplying the energy thereof.

More specifically, the communication interface unit 120 is connected with the communication network to transmit and receive data.

Further, the display unit 140 displays the product information. In this case, in implementing the display unit 140, a segment display method, a dot matrix method, a graphic method, and the like can be applied.

Meanwhile, by considering distinct characteristics of a user environment such as a distribution store, i.e., specialized in the shape and display of the electronic tag 100 must attract attention, installation must match a surrounding environment, and a layout must be able to be frequently changed in a space where a lot of people move, the communication network for transferring the information of the server 10 to the electronic tag 100 may adopt a wireless communication network which is easier in the change of installation than a wired communication network and the power supply unit 150 may also be implemented by a battery.

Further, the communication interface unit 120 may also transmit and receive data to and from the server 10 through the wireless network.

In this case, the wired/wireless communication converting unit 20 may be provided between the server 10 and the communication interface unit 120.

The control unit 110 processes data received from the server 10 and displays the processed data in the display unit 140 and may serve to manage power.

Further, the control unit 110 is configured to possess time information appropriated in real time.

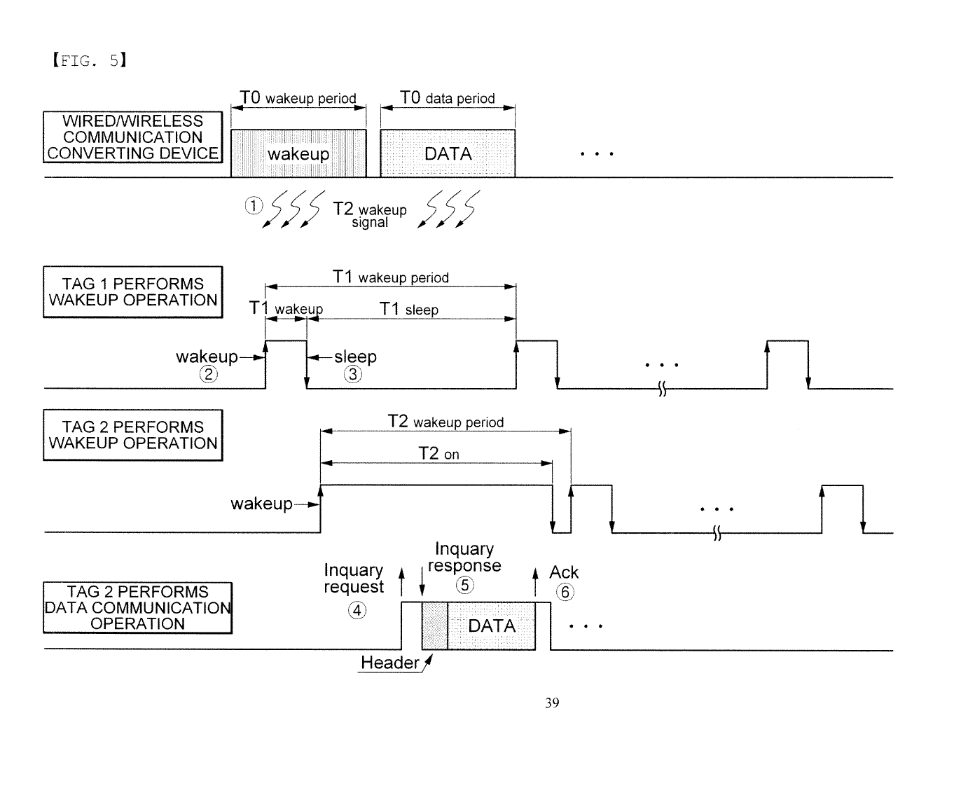

FIG. 4 is a block diagram showing a configuration of an electronic tag 200 according to another exemplary embodiment of the present invention.

Referring to FIG. 4, the electronic tag 200 may additionally include a time appropriating unit 211 connected with the control unit 110.

Herein, time appropriation refers to a process matching a time in real time by increasing a time of hour, minute, or second unit at a predetermined period on the basis of predetermined time information (alternatively, a time value).

The time appropriating unit 211 may include a microcontroller including a real time clock, a timer and/or counter, and an oscillator.

The control unit 110 controls the flow of all signals of the electronic tag 200 and may be generally implemented as a microcontroller (MCU) of an 8 bit class or more. The MCU adopts an oscillator of approximately 32 KHz and the RTC counts seconds to appropriate a time and a date on the basis of a clock signal of the oscillator.

Further, a timer and/or counter circuit block is embedded in the microcontroller, which may appropriate a time of a predetermined period in software.

Meanwhile, the electronic tag 200 further includes a register 260 which may store time information.

Further, the electronic tag 200 further includes a time setting register Timeset R to appropriate and store time information in real time.

Further, the register 260 may include a first register R1, a second register R2, and a time setting register Timeset R.

In this case, time information lastly acquired from the outside is stored in the first register R1 and the time information acquired from the outside is stored in the second register R2. The time information acquired from the outside may be appropriated and stored in the time setting register Timeset R in real time.

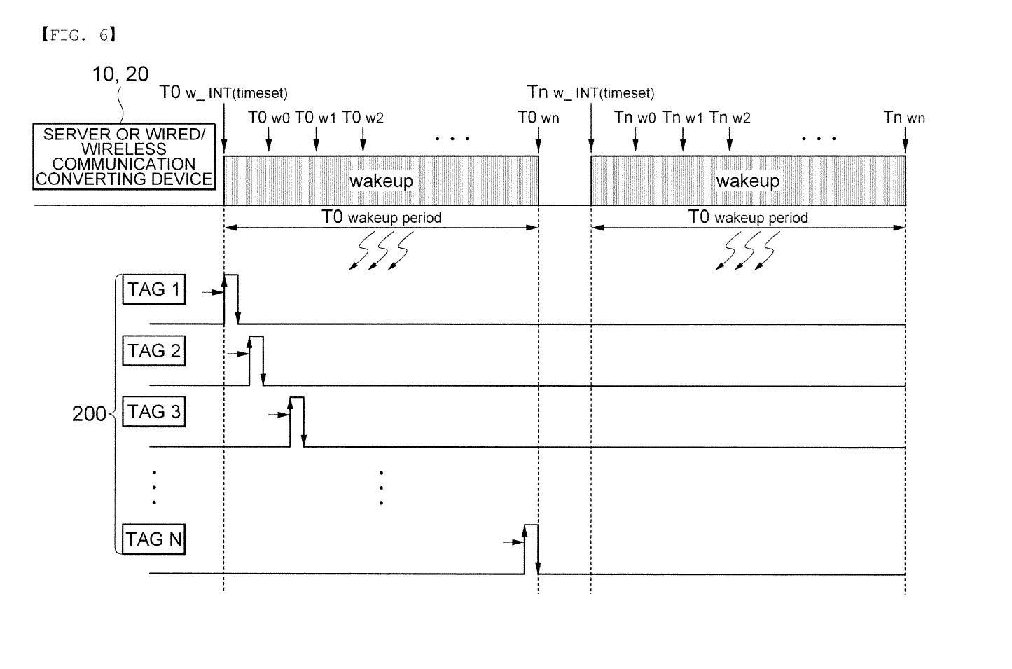

FIG. 5 is a diagram showing a data communication process according to an exemplary embodiment of the present invention.

The electronic tags 200 maintain a sleep mode for a considerable period of time in order to minimize power consumption thereof and verifies a communication state and whether its own identity (ID) is called by wakeup (\textcircled{2}) at a predetermined period.

Referring to FIG. 5, for example, electronic tag 1 (TAG 1) verifies whether its own identity (ID) is included in a wakeup signal (\textcircled{1}) of the server 10 or the wired/wireless communication converting unit, that is, whether itself is called, for its own wakeup period (T1wakeup). If TAG 1 is not called, the process proceeds to the sleep mode (\textcircled{3}) again to reduce unnecessary energy consumption.

If its own identity is present in the wakeup signal of the wired/wireless communication converting unit 20 (in the case of electronic tag 2 (TAG 2) in FIG. 5), TAG 2 transmits a signal for requesting information required for itself to the wired/wireless communication converting unit 20. This is referred to as an inquiry request (\textcircled{4}) and a converting device receiving a request for information from electronic tag 2 (TAG 2) transmits required data information. This is referred to as a inquiry response (\textcircled{5}). After electronic tag 2 (TAG 2) receives all required information, electronic tag 2 (TAG 2) acknowledges (\textcircled{6}) a signal for completion of receiving information and completes predetermined communication.

In a system of transferring information between the server 10 or the wired/wireless communication converting unit 20 and the electronic tag 200, a data signal generated by the wired/wireless communication converting unit 20 may have various formats according to a technique of the communication implementation. In general, the wakeup signal has a packet data format and identity of a target which TAG 2 will transfer information to, i.e., the electronic tag 200 requiring a call becomes a main content.

Data transferring actual information after wakeup is, in detail, blocked into a header and data. The header may include information for ensuring communication reliability of data such as an amount of information for a subsequent payload (data), the length of data, and the like.

Meanwhile, a method for setting time information of an ESL system according to an exemplary embodiment of the present invention may include (a) transmitting time information set to the server 10 to the electronic tags 100 and 200 through the wired/wireless communication network; (b) receiving and storing time information in the electronic tags 100 and 200; and (c) appropriating and possessing the stored time information in real time.

In this case, in step (a), an electronic tag wakeup command signal to which time information is coupled may be transmitted from the server 10.

Further, in step (b), the electronic tags 100 and 200 may receive and store the time information transmitted from the server 10 in a wakeup state while repeating wakeup and sleep at a predetermined period.

Further, in step (b), the electronic tags 100 and 200 may receive the time information and store the received time information in a register.

Further, step (c) may be performed by appropriating or storing the stored time information in real time by a timer and/or a counter or appropriating and storing the stored time information in real time by a real-time clock.

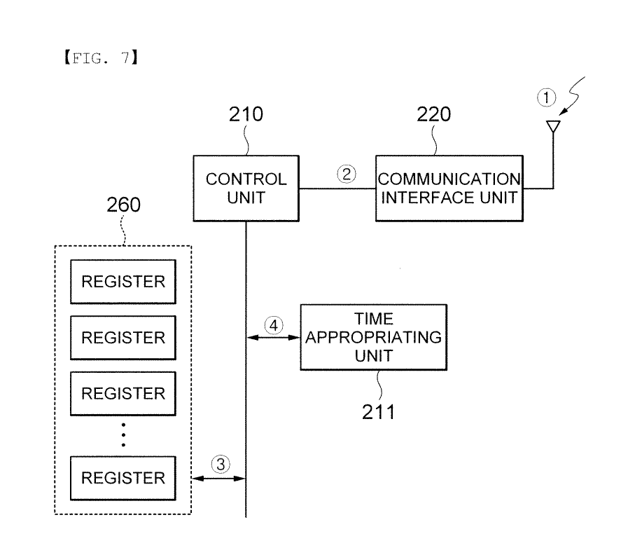

FIG. 6 is a diagram showing a data communication process according to another exemplary embodiment of the present invention.

Referring to FIG. 6, in the flow of a time that successively passes, since wakeup times of the electronic tags 100 and 200 are different from each other within a wakeup signal generation period (T0), the time information acquired by the electronic tags 100 and 200 may actually have a slight error.

That is, in FIG. 6, as electronic tag 1 (TAG 1) wakes up at the time substantially matching set time information to acquire time information, it may be determined that TAG 1 is synchronized with the actual time of the server 10 and the wired/wireless communication converting unit 20; however, electronic tag N (TAG N) wakes up at the same wakeup signal period T0 as the electronic tag (200) 1 to acquire the same time information. However, since the actual time has already considerably been delayed, a considerable error may occur in time synchronization.

In order to reduce the error, the method for setting the time information of the ESL system according to the exemplary embodiment of the present invention may include: n times-sectioning dividing the wakeup signal generated by the server 10 or the wired/wireless communication converting unit 20 and transmitting real-time time information corresponding to the sectioned wakeup signal together with the wakeup signal; and storing, by the electronic tags 100 and 200 which wake up at predetermined wakeup periods, respectively, the time information received at the time of wakeup, and appropriating and possessing the stored time information in real time.

That is, segmented time information that accurately match sectioned times by n times-sectioning the period of the same wakeup signal generated for a predetermined time is inserted.

In FIG. 6, since electronic tag 1 (TAG 1) that wakes up between T0w_init(timeset) and T0w0 acquires a time value of T0w_init(timeset) and electronic tag (200) 2 that wakes up between T0w1 and T0w2 acquires a time value updated to T0w1, an error of the time information acquired depending on a wakeup time difference can be solved.

Of course, as a time period of insertion of the time information is denser, the error in time information acquired by the electronic tags 100 and 200 may be reduced. However, there is a limit to transmit the time information to the electronic tags 100 and 200 according to a successive passage of time in terms of system operation.

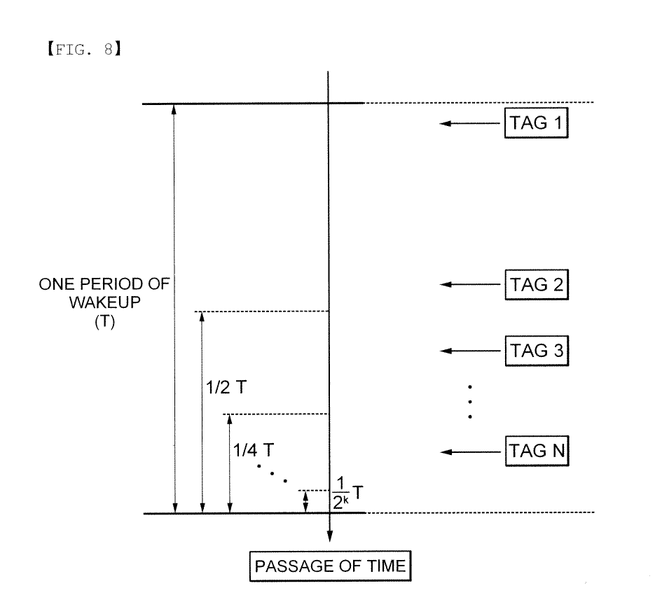

FIG. 7 is a diagram showing a time acquiring path of an electronic tag 200 according to an exemplary embodiment of the present invention.

When the wakeup signal (\textcircled{1}) transmitted from the server 10 or the wired/wireless communication converting unit 20 is received to acquire the time information (\textcircled{2}), the control unit 110 recognizes the acquired time information as a time set value and moves the acquired time information to the time setting register Timeset R (\textcircled{3}). The time appropriating unit 211 appropriates the passage of time by using the real-time clock or timer/counter calculation on the basis of the set value of the time setting register Timeset R to convert the value of the time setting register Timeset R.

Through such a process, the electronic tag 200 may have the time information synchronized with the server 10 (alternatively, the wired/wireless communication converting unit 20) within its own processing section.

At the time of initially installing the electronic tag 200 (alternatively, a predetermined time is available), information regarding a current time possessed by the server 10 (alternatively, the wired/wireless communication converting unit 20) is loaded in addition the wakeup signal and transmitted together with the time of transmitting the current time information T0w_init(timeset). Since the signal transmitted at that time is transferred in a broadcasting scheme, all tags that wake up by matching their own operating periods may acquire the time information regardless of whether their identities are included in the wakeup signal. The control unit 110 processes the time information and records the processed time information in an additional register and performs time appropriation from that time to count the time.

Further, the current time information may be transmitted while being included in a header of a data signal. Since the electronic tag 200 receives the time information together whenever receiving the data from the server 10 after initial time information is set, the electronic tag 200 may continuously update and calibrate time information which the electronic tag 200 knows.

Meanwhile, in the time setting method, each electronic tag 200 may have a time setting value synchronized with the server 10 (alternatively, the converting device) by using the wakeup operation, but more specifically, times which the electronic tags 200 possess may be different from each other. The reason therefor is that wakeup periods and times of the electronic tags 200 may be different from each other.

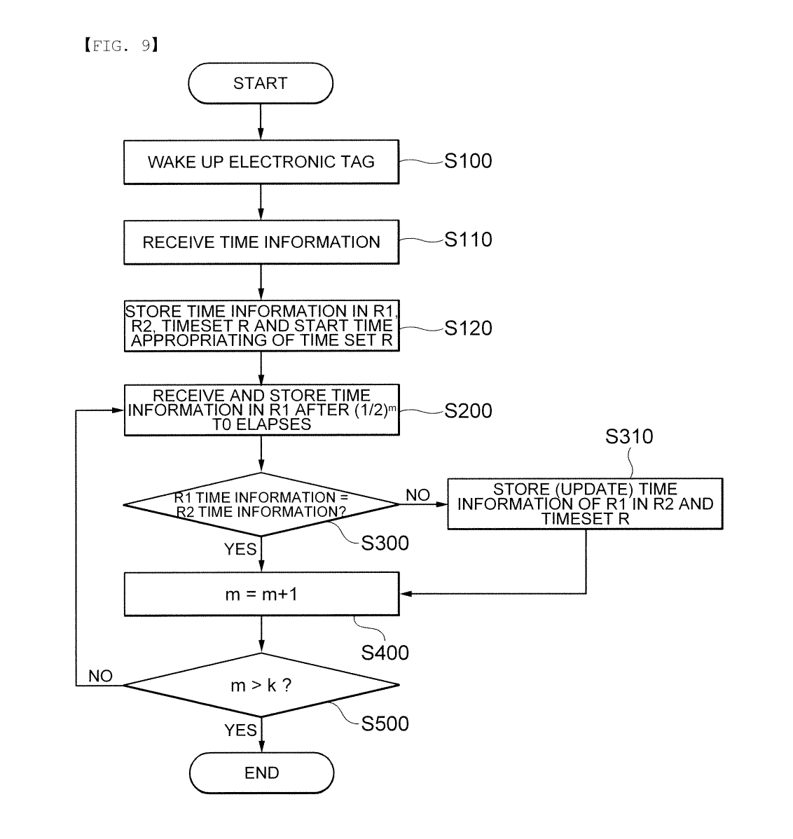

FIG. 8 is a diagram showing a time series relationship between a wakeup time and a wakeup period. Referring to FIG. 8, although the electronic tags 200 wake up at different times, the electronic tags 200 have the same time value, and as a result, the time information possessed by the electronic tags 200 has an error between the electronic tags 200 or between the electronic tags 200 and the server 10.

Therefore, the time values possessed by the electronic tags 200 must be calibrated. A method for setting time information of an ESL system according to an exemplary embodiment of the present invention including a time calibration concept will now be described.

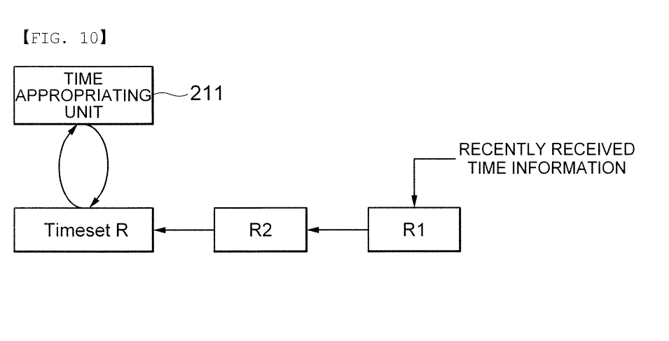

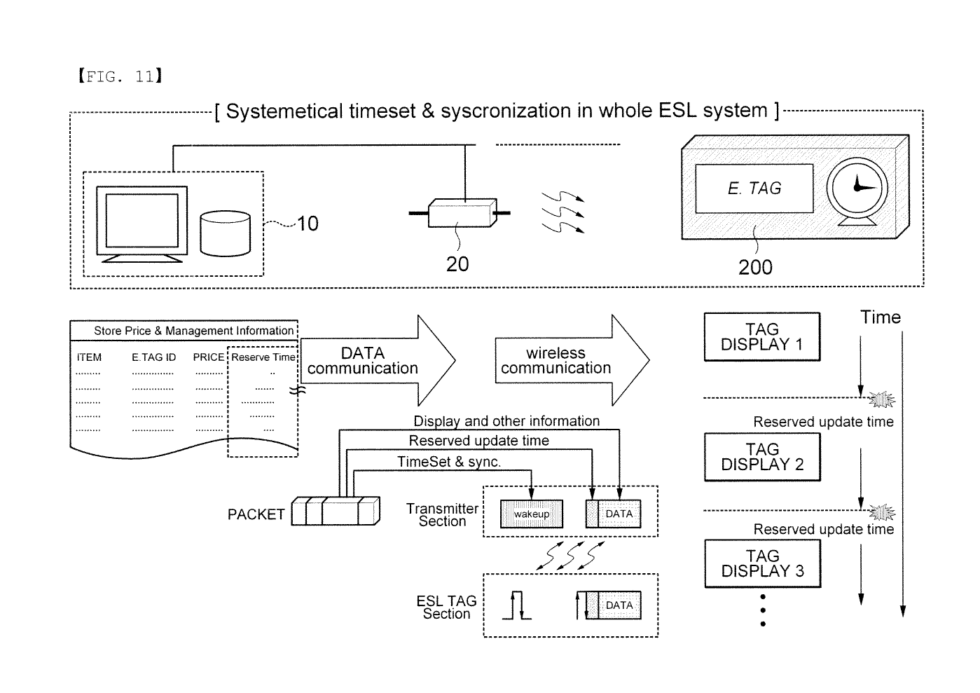

FIG. 9 is a flowchart showing a time information calibrating process according to an exemplary embodiment of the present invention and FIG. 10 is a block diagram showing a configuration applied at the time of calibrating time information according to an exemplary embodiment of the present invention.

Referring to FIGS. 9 and 10, a method for setting time information of an ESL system according to another exemplary embodiment of the present invention may include transmitting the time information, receiving and storing the time information, re-receiving and storing the time information after a predetermined time elapses, comparing the stored time information, and updating or repetitively performing a time setting register Timeset R.

First, the time information set in a server 10 is transmitted through a wired/wireless communication network (not shown).

Next, when an electronic tag 200 wakes up (S100), the time information is received (S110) and stored in each of a first register R1, a second register R2, and a time setting register Timeset R, and the time information stored in the time setting register Timeset R is appropriated in real time (S120).

Next, the electronic tag 200 wakes up again to receive the time information after ½^{m} of a period T0 of a wakeup signal of the server 10 elapses and stores the received time information in the first register R1 (S200). In this case, m represents an integer which starts from 1 and increases by 1.

Next, the time information stored in the first register R1 and the time information stored in the second register R2 are compared with each other (S300) and if they are different from each other, the time information stored in the second register R2 and the time setting register Timeset R is substituted with the time information stored in the first register R1 (S310).

Next, 1 is added to m (S400) and if the value is larger than k which is the predetermined number of times, the process is terminated (S500).

Next, if m is equal to or small than k, the electronic tag 200 wakes up again to receive the time information after ½^{m} of the period T0 of the wakeup signal of the server 10 has elapsed and fed back to the process of storing the time information in the first register R1 (S200) and the process is performed again (S500).

Further, if the time information stored in the first register R1 and the time information stored in the second register R2 are the same as each other, the process of adding 1 to m is performed without substituting the time information stored in the time setting register.

By this configuration, the wakeup period of the electronic tag 200 whenever the feedback is repeated is ½ shorter than the wakeup period before the feedback so as to decrease an error.

Meanwhile, the feedback repetition number of times, k is adjusted to synchronize the time information possessed by the electronic tag 200 with the time information of the server 10 within a predetermined error range.

Further, the wired/wireless communication converting unit 20 is provided between the server 10 and the electronic tag 200 to allow the wired/wireless communication converting unit 20 to receive and transmit the time information set in the server 10 through the wired/wireless communication network.

A method for setting time information of an ESL system according to anther exemplary embodiment of the present invention may include: transmitting the time information from a server 10; waking up all electronic tags 200 included in the ESL system at once; and storing time information at the time when the electronic tag 200 wakes up and appropriating and possessing the stored time information in real time, in operating the ESL system including the server 10 and the electronic tag 200.

In this case, the wired/wireless communication converting unit 20 is provided between the server 10 and the electronic tag 200 and when the server 10 transmits time information, the wired/wireless communication converting unit 20 receives the time information and transmits the received time information to the electronic tag 200.

Meanwhile, in order to update the display information of the electronic tag 200 according to the related art, update information is transmitted from the server 10 to the electronic tag 200 whenever updating is required.

However, according to the related art, since required data must be transmitted from the server 10 to the electronic tag 200 whenever data updating is required, management is inconvenient and in the case where a lot of electronic tags 200 are required to be updated during a large-scale discount event at a predetermined date or a predetermined time, communication traffic rapidly increase. Since the increase of the traffic may cause system failure or malfunction, additional resources are required in order to prevent the system failure or malfunction and cost increases.

Further, when the serve 10 transmits data, data transmitted in real time is reflected in the electronic tag 200. Therefore, in the case where malfunction occurs or data transmission itself is erroneous, incorrect information is exposed as it is, and as a result, it is difficult to calibrate the error and in some cases, considerable damages may occur before the error is calibrated.

Therefore, in the present invention, a method capable of making different the time when the server 10 transmits the data and the time when the data is reflected to the electronic tag 200 is provided.

FIG. 11 is a diagram showing a method for operating an ESL system according to an exemplary embodiment of the present invention. Referring to FIG. 11, in the method for operating an ESL system according the exemplary embodiment of the present invention, a signal transmitted from the server 10 to the electronic tag 200 includes execution reservation time information, and the electronic tag 200 operates in accordance with the execution reservation time information included in the signal received from the server 10, in the method for operating the ESL system and/or the method for setting time information of the ESL system.

In this case, a data signal transmitted from the server 10 to the electronic tag 200 may include electronic tag identity, product information, and execution reservation time information.

Further, the data signal transmitted from the server 10 to the electronic tag 200 is constituted by a header and data, and the header may include the execution reservation time information.

According to the exemplary embodiment, the electronic tag 200 must be capable of possessing the time information.

Further, the time information of the server 10 and the time information of the electronic tag 200 may be within a predetermined error range. That is, whenever a predetermined time elapses, a process of calibrating and maintaining a time error generated in various deviations such as an oscillation period between the devices needs to be provided.

When such a condition is satisfied, it is possible to solve management inconvenience in that required information must be transmitted from the server 10 whenever updating and clustering of communication traffic which may be solved when a lot of electronic tags 200 to be updated are clustered at a predetermined time (when discount sale is performed at a predetermined date or a predetermined time) by applying the method for operating the ESL system according to the exemplary embodiment of the present invention. Further, in the case of the large-sized distribution store, when a lot of electronic tags 200 and a plurality of communication converting devices coexist, efficient distribution operation of the communication traffic may be adaptable, and as a result, the method for operating the ESL system may be very useful in designing a network.

According to exemplary embodiments of the present invention, there can be provided electronic tags capable of possessing time information and there can be provided an ESL system including the electronic tags.

Further, since an error in time information between a server and the electronic tags may be reduced in the ESL system including the electronic tags, accuracy of time information synchronization of the electronic tags and the ESL system is improved.

Since time information permitting only an error of a small range is synchronized between the electronic tags and the server, a reservation function can be used in the ESL system on the basis of the synchronized time information.

When the reservation function is used, data traffic can be distributed and even when data is not normally transmitted and received between the server and the electronic tags, sufficient time to calibrate the abnormal transmission/reception can be ensured.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electronic tag displaying information of a product transmitted from a server, the electronic tag comprising:
a communication interface unit transmitting and receiving data;
a display unit displaying the information of the product;
a power supply unit supplying power;
a control unit controlling the communication interface unit, the display unit, and the power supply unit and processing data; and
a memory unit storing data required to process data in the control unit,
wherein the control unit possesses time information appropriated in real time.

2. The electronic tag according to claim 1, further comprising a real-time clock connected to the control unit and appropriating time information.

3. The electronic tag according to claim 1, further comprising a timer and/or counter connected to the control unit and appropriating time information.

4. The electronic tag according to claim 1, wherein the control unit includes a microcontroller with an oscillator.

5. The electronic tag according to claim 1, further comprising a register storing the time information.

6. The electronic tag according to claim 1, further comprising a time setting register appropriating and storing the time information in real time.

7. The electronic tag according to claim 1, further comprising:
a time setting register appropriating and storing time information acquired from the outside in real time;
a second register storing time information acquired from the outside; and
a first register storing time information lastly acquired from the outside.

8. An ESL system, comprising:
at least one electronic tag according to any one of claims 1 to 7; and
a server including a database storing product information and transferring a command and data to the electronic tag.

9. The ESL system according to claim 8, further comprising a wired/wireless communication converting unit relaying a wireless communication between the server and the electronic tag.

10. The ESL system according to claim 8, wherein time information of the server and time information of the electronic tag are synchronized with each other.

11. A method for setting time information of an ESL system, the method comprising: in operating the ESL system including a server and an electronic tag,
(a) transmitting time information set in the server to the electronic tag through a wired/wireless communication network;
(b) receiving and storing time information from the electronic tag; and
(c) appropriating and possessing the stored time information in real time.

12. The method according to claim 11, wherein in step (a), an electronic tag wakeup command signal coupled with time information is transmitted from the server.

13. The method according to claim 11, wherein in step (b), the electronic tag receives and stores the time information transmitted from the server in wakeup while repeating wakeup and sleep at a predetermined period.

14. The method according to claim 11, wherein in step (b), the electric tag receives time information and stores the received time information in a register.

15. The method according to claim 11, wherein in step (c), the stored time information is appropriated and stored in real time by a timer and/or counter.

16. The method according to claim 8, wherein in step (c), the stored time information is appropriated and stored in real time by a real-time clock.

17. A method for setting time information of an ESL system, the method comprising: in operating the ESL system including a server and an electronic tag,
n times-sectioning dividing the wakeup signal generated by the server and transmitting real-time time information corresponding to the sectioned wakeup signal together with the wakeup signal; and
storing, by the electronic tags which wake up at predetermined wakeup periods, respectively, the time information received at the time of wakeup, and appropriating and possessing the stored time information in real time.

18. A method for setting time information of an ESL system, the method comprising: in operating the ESL system including a server, a wired/wireless communication converting unit, and an electronic tag,
synchronizing time information of the server and time information of the wired/wireless communication converting unit with each other;
n times-sectioning dividing the wakeup signal generated by the wired/wireless communication converting unit and transmitting real-time time information corresponding to the sectioned wakeup signal together with the wakeup signal; and
storing, by the electronic tags which wake up at predetermined wakeup periods, respectively, the time information received at the time of wakeup, and appropriating and possessing the stored time information in real time.

19. A method for setting time information of an ESL system, the method comprising: in operating the ESL system including an electronic tag with a first register, a second register, and a time setting register, and a server,
(a) transmitting time information set in the server through a wired/wireless communication network;
(b) receiving the time information and storing the received time information in each of the first register, the second register, an the time setting register when the electronic tag wakes up and appropriating the time information stored in the time setting register in real time;
(c) waking up, by the electronic tag, again to receive the time information after ½^{m} of the period T0 of the wakeup signal of the server has elapsed and storing the received time information in the first register;
(d) comparing the time information stored in the first register and the time information stored in the second register with each other and substituting the time information stored in the second register and the time setting register with the time information stored in the first register when the time information stored in the first register and the time information stored in the second register are different from each other;
(e) adding 1 to m; and
(f) terminating the process when m passing through step (e) is larger than the predetermined number of times, k and feeding back the process to step (c) when m is equal to or smaller than k.

20. The method according to claim 19, wherein when the time information stored in the first register and the time information stored in the second register are the same as each other in step (d), step (e) is performed.

21. The method according to claim 19, wherein the wired/wireless communication converting unit is provided between the server and the electronic tag, and
in step (a), the wired/wireless communication converting unit receives the time information set in the server and transmits the received time information through a wired/wireless communication network.

22. A method for setting time information of an ESL system, the method comprising: in operating the ESL system including a server and an electronic tag,
transmitting time information from the server;
waking up all electronic tags included in the ESL system at once; and
storing time information received at the time when the electronic tag wakes up and appropriating and possessing the stored time information in real time.

23. The method according to claim 22, wherein a wired/wireless communication converting unit is provided between the server and the electronic tag, and
when the server transmits time information, the wired/wireless communication converting unit receives the time information and transmits the received time information to the electronic tag.

24. A method for operating an ESL system according to any one of claims 8 to 10, wherein a signal transmitted from the server to the electronic tag includes execution reservation time information, and
the electronic tag operates in accordance with the execution reservation time information included in the signal received from the server.

25. The method according to claim 24, wherein a data signal transmitted from the server to the electronic tag includes electronic tag identity, product information, and execution reservation time information.

26. The method according to claim 24, wherein the data signal transmitted from the server to the electronic tag is constituted by a header and data, and
the header includes the execution reservation time information.

27. A method for operating an ESL system, wherein in using a method for setting time information of the ESL system according to any one of claims 11 to 23,
a signal transmitted from a server or a wired/wireless communication converting unit to an electronic tag includes execution reservation time information, and
the electronic tag operates in accordance with the execution reservation time information included in the signal received from the server or the wired/wireless communication converting unit.

28. The method according to claim 27, wherein a data signal transmitted from the server or the wired/wireless communication converting unit to the electronic tag includes electronic tag identity, product information, and execution reservation time information.

29. The method according to claim 27, wherein the data signal transmitted from the server or the wired/wireless communication converting unit to the electronic tag is constituted by a header and data, and
the header includes the execution reservation time information.
